(19) United States
(12) Patent Application Publication
(10) Pub. No.: US 2005/0260760 A1
(43) Pub. Date: Nov. 24, 2005

(54) Measuring device for monitoring sterilization conditions

(76) Inventor: Gerhard Hucker, Mondorf-les Bains (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/505,973

(22) PCT Filed: Jan. 24, 2003
(86) PCT No.: PCT/EP03/00895

§ 371 Date: Aug. 25, 2004

(30) Foreign Application Priority Data
Feb. 5, 2002 (DE) 202-01-752.4

(51) Int. Cl. G01N 15/06

(52) U.S. Cl. 436/1; 422/68.1

(57) ABSTRACT

The invention relates to a measuring device for monitoring the sterilization conditions in a sterilization chamber. Said measuring device comprises a data sensor (1) that can be introduced into the sterilization chamber, a data read-out device (2) outside the sterilization chamber, and an evaluation unit (3). The data sensor (1) has a housing (7) in which a control (8), a power supply unit (9), a data memory (10) and a pressure sensor (13), and the data read-out device (2) with a data output (12) are disposed. The data sensor (1) is linked via a sensor cable (5) with semiconductor elements (6) that can be introduced into the sterilization chamber and stores the temperatures measured at a plurality of positions in the sterilization chamber.

The subject of the invention is a measuring device for monitoring the sterilization conditions in a sterilization chamber comprised of a data pickup which can be introduced into the sterilization chamber, a data readout device outside the sterilization chamber and an evaluating unit.

Measuring devices for monitoring the sterilization conditions in a sterilization chamber are already known. The international patent application WO 93/21964 describes a device for monitoring the sterilization and in which the measured conditions determined within the sterilization chamber are transmitted to an external data writer by radio frequency transmission. The international patent application WO/95/32742 describes a test device for detecting the sterilization conditions in a sterilizing apparatus. In this case, at two precisely predetermined locations within the sterilization apparatus, the sterilization conditions are measured with precision.

Such measuring devices always are comprised of two parts, namely, the measuring device which measures the sterilization conditions in the sterilization chamber and a second part, the data evaluating device. The measuring device remains in the sterilization chamber until the sterilization process is fully concluded. At predetermined time intervals, the parameters of pressure, temperature and moisture level are measured by this measuring device and are either transmitted by an antenna to the evaluating device or the obtained data is stored and evaluated after removal of the measuring device from the sterilization chamber. Thus, it is possible to document the fact that the article treated in the sterilization chamber have been sterilized correctly and in accordance with regulations. The temperature measurement is carried out in both of the aforementioned embodiments exclusively at a single point or at two points within the sterilization chamber.

It has, however, been found from a plurality of investigations, that local temperature gradients or local temperature differences have a significant influence upon the quality of the sterilization. In order to insure that the sterilization temperature in the entire sterilization chamber is sufficiently high, it is necessary to measure the temperature at a multiplicity of locations in the sterilization chamber. The previously used temperature sensors do not permit combining a multiplicity of temperature sensors in a single measuring unit to thereby insure a rapid thermal response.

This problem can be resolved with a measuring device for monitoring the sterilization conditions in a sterilization chamber which is comprised of a data pickup 1 which can be introduced into the sterilization chamber, a data readout device 2 outside the sterilization chamber and an evaluating unit 3, whereby the data pickup 1 has a housing 7 in which a control unit 8, an electric current supply unit 9, a data memory 10 and a pressure sensor 18 are provided and whereby the data readout device 2 has a data output 12, such that the data pickup 1 is connected by sensor cables 5 with semiconductor elements 6 in the sterilization chamber and can store measured temperatures from the multiplicity of locations in the sterilization chamber.

With the refinement according to the invention whereby the temperature sensors are provided in the form of semiconductor elements, it is possible to determine the temperature at various locations in the sterilization chamber over a short thermal response interval with precision. The measuring device according to the invention, is described in greater detail in conjunction with the accompanying drawing:

It shows:

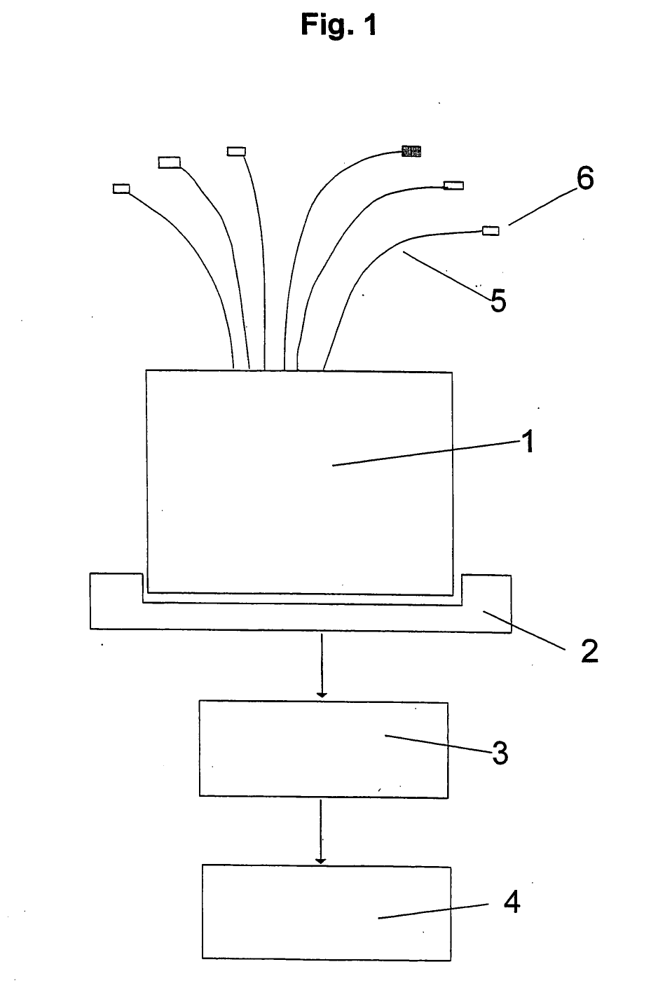

FIG. 1 a schematic illustration of the measuring device according to the invention for monitoring sterilization conditions; and

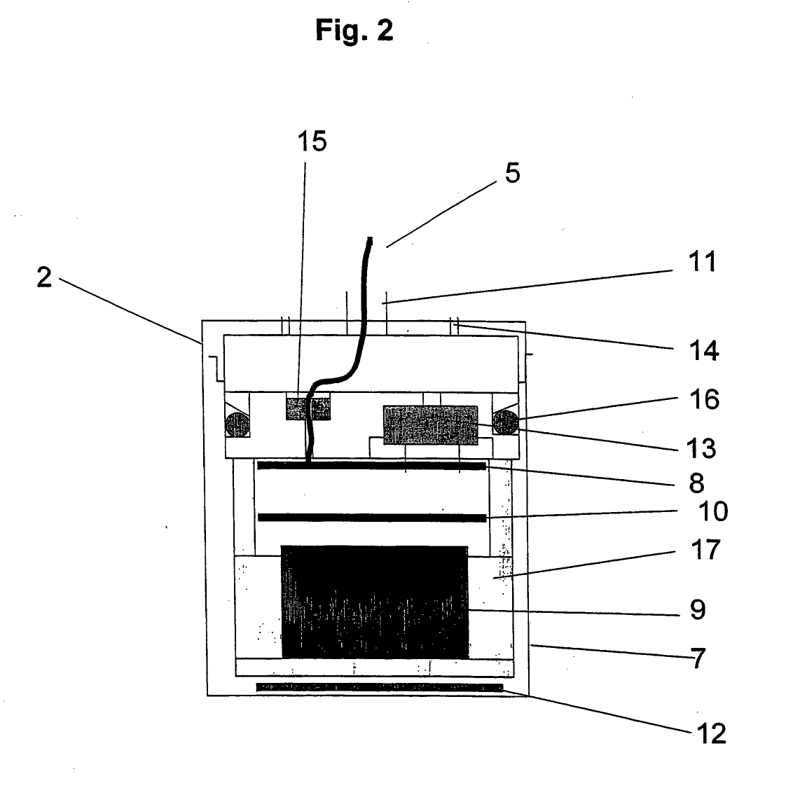

FIG. 2 a schematic illustration of the data pickup.

FIG. 1 shows the measuring device according to the invention comprised of the data pickup which is connected by sensor cables 5 with semiconductor elements 6 which can be introduced into the sterilization chamber and by means of which temperature measurements can be made at a multiplicity of locations in the sterilization chamber. These temperatures are stored in the data pickup and can be readout by a data readout device 2. From there, the data can be, via an evaluating unit, for example, a personal computer, made optically and graphically visible and can be printed by a printer connected thereto.

FIG. 2 shows the data pickup which is especially suitable for monitoring the sterilization process. The data pickup according to the invention is comprised of an outer housing 7 which is made from stainless steel, plastic or another suitable pressure resistant and temperature resistant as well as inert material. In the interior of the housing 7, there is located a control device 8, an electric current supply unit 9, a data memory 10 and a pressure sensor 13. The electric current supply unit 9 can, for example, be a rechargeable battery which can be charged via charging contacts which have not been shown. The energy supply can, however, also derive from a battery which can be inserted into a battery holder provided for that purpose. The battery holder is surrounded by a thermal insulation 17 to prevent damage to it from the severe conditions within the sterilization chamber. In addition, a pressure sensor 13, a pressure equalization passage 14 as well as a sensor 15 is measuring the moisture level can be seen. In the illustrated embodiment, the pressure sensor is mounted directly on the inner side of the housing 7. The control unit 8 is wired with the individual sensors. The data measured by the sensors is fed to the control unit 8 and there processed and subsequently stored in the data storage 10.

The data storage 10 is connected with the data output 12 and the data transfer can be effected by a contact plate for electrical data transfer. It is, however, also possible to transfer the data by optical, mechanical or acoustic data transfer to the data readout device. The temperature sensors 6 which are comprised of semiconductor elements are connected via flexible sensor cables so that they can measure the precise temperature at any location of the sterilization chamber. The semiconductor elements used provide a brief [rapid] thermal response and also have relatively small dimensions. In an especially preferred embodiment 8 or even 16 thermosensors can be connected with the control unit 8. Thus a precise temperature determination at all points within the sterilization chamber is possible. The housing 7 has an opening 11 as a cable passthrough to the sterilization chamber. In addition, a sealing ring 16 is provided which prevents the penetration of hot moist air under pressure into the data logger.

The readout device 2 schematically shown in FIG. 1 is preferably connected with an evaluating device, for example, a personal computer 3 and a printer 4. The data readout device 2 advantageous is formed with a recess in which the data pickup 1 can be docked so that a data transfer between the data pickup 1 and then data readout device 2 can be insured. The data logger is thus contacted through 2 spring contacts. The data exchange can be effected over a so-called two-wire interface. The readout device can advantageously be supplied with voltage through the USBbUS. An additional network component is unnecessary.

The special advantage of the measuring device according to the invention is achieved through the use of semiconductor elements as temperature sensors. They have short thermal response times, have high long term stability and enable with the use of up to 16 temperature sensors an exact display of the temperature conditions in the sterilization chamber. The evaluation electronics can be easily controlled or programmed while the evaluation of the measurement signals can permit use of thermoelements for a variety of applications which have not been achievable heretofore with a smaller logger in a sterilizer application.

### REFERENCE CHARACTER LIST

1 Data pickup (data logger)
2 Data readout device
3 Evaluating Unit (PC)
4 Printer
5 Sensor Cable
6 Semiconductor element (temperature sensor)
7 Housing
8 Controlled Device
9 Electronic Current Supply Unit
10 Data Memory
11 Capable Passthrough to the sterilization
12 Contact Plate
13 Pressure Sensor
14 Pressure Equalization
15 Sensor for measuring moisture
16 Sealing Ring
17 Thermal Insulation

1. A measuring device for monitoring the sterilization conditions in a sterilization chamber comprised of a data pickup (1) which is introduced into the sterilization chamber, temperature sensors (6), a data memory (10) for storing the measured temperatures, a data readout unit (2) outside the sterilization chamber and an evaluation unit (3), whereby the data pickup (2) has a housing (7) in which a control unit (8), an electric current supply unit (9) and a pressure sensor (13) are located and the data readout unit (2) is provided with a data output (12), characterized in that the temperature sensors (6) comprised of semiconductor elements are introduced into the sterilization chamber and connected by flexible cable sensors (5) with the data pickup (1) so that at every location of the sterilization chamber the exact temperatures is measurable.

2. The measuring device according to claim 1 characterized in that the pressure sensor (13) is received in the housing (7) of the data pickup (1).

3. The measuring device according to claim 1, characterized in that the data pickup (1) apart from a pressure sensor (13) and a multiplicity of temperature sensors (6) has a further sensor (15) for measuring the relative humidity.

4. The measuring device according to claim 1, characterized in that the data transfer is effected from the data pickup (2) to the data readout unit (2) electrically, optically, mechanically or acoustically.
